(19) United States
(12) Patent Application Publication
(10) Pub. No.: US 2016/0019447 A1
(43) Pub. Date: Jan. 21, 2016

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Tomoyuki MITSUHASHI, Kanagawa (JP); Yuichi NISHIKUNI, Kanagawa (JP); Masaru OKUTSU, Kanagawa (JP); Daigo HAMA, Kanagawa (JP)

(73) Assignee: FUJI XEROX CO., LTD., Tokyo (JP)

(21) Appl. No.: 14/641,713

(22) Filed: Mar. 9, 2015

(30) Foreign Application Priority Data
Jul. 17, 2014 (JP) 2014-146915

(51) Int. Cl. G06K 15/02; H04N 1/56

(52) U.S. Cl. CPC G06K 15/1878; H04N 1/56

(57) ABSTRACT

An information processing apparatus include an acquisition unit and a recording unit. The acquisition unit acquires, for each page, image data including a color value for each of plural pixels and information that indicates a type of an object for each of the pixels. The recording unit records a number of pages including plural pixels, a difference between the color values of which is less than a first threshold determined in advance and the types of the objects of which are different from each other.

### CROSS-REFERENCE TO RELATED APPLICATIONS

This application is based on and claims priority under 35 USC 119 from Japanese Patent Application No. 2014-146915 filed Jul. 17, 2014.

### BACKGROUND

(i) Technical Field

The present invention relates to an information processing apparatus and a non-transitory computer readable medium.

(ii) Related Art

An information processing apparatus that executes a process that matches the frequency of appearance of plural colors included in image data has been known.

### SUMMARY

According to an aspect of the present invention, there is provided an information processing apparatus including: an acquisition unit that acquires, for each page, image data including a color value for each of plural pixels and information that indicates a type of an object for each of the pixels; and a recording unit that records a number of pages including plural pixels, a difference between the color values of which is less than a first threshold determined in advance and the types of the objects of which are different from each other.

### BRIEF DESCRIPTION OF THE DRAWINGS

An exemplary embodiment of the present invention will be described in detail based on the following figures, wherein:

FIG. 1 illustrates the overall configuration of an information processing system;

FIGS. 2A and 2B illustrate the data format of image data;

FIG. 3 illustrates an example of a color level difference;

FIG. 4 is a block diagram illustrating the functional configuration of an image forming device;

FIG. 5 illustrates a color region;

FIG. 6 is a block diagram illustrating the hardware configuration of the image forming device;

FIG. 7 is a flowchart illustrating a process performed by the image forming device;

FIG. 8 illustrates number-of-pixels information for a certain page;

FIG. 9 illustrates number-of-pixels information after an HSV conversion; and

FIG. 10 illustrates an example in which the number of pages with a risk of occurrence of a color level difference is recorded.

### DETAILED DESCRIPTION

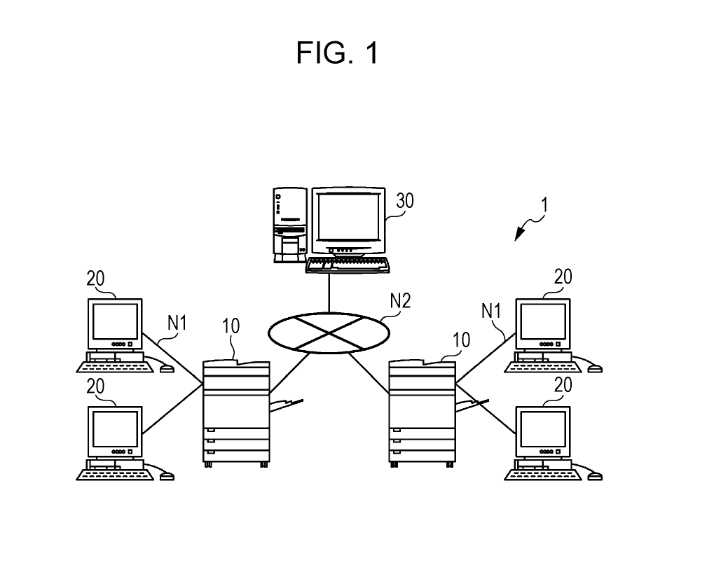

FIG. 1 illustrates the overall configuration of an information processing system 1 according to an exemplary embodiment of the present invention. The information processing system 1 manages the characteristics of colors in pages printed by an image forming device 10 in order to improve the print quality. The information processing system 1 includes plural image forming devices 10 (examples of the information processing apparatus), plural personal computers 20 (hereinafter referred to as “PCs 20”), and a server device 30. The image forming devices 10 function as a copier, a printer, a scanner, and a facsimile. The PCs 20 are devices that transmit a command to the image forming devices 10. The PCs 20 are connected to the image forming devices 10 via a communication line N1. The server device 30 manages the information processing system 1. The server device 30 manages the characteristics of colors in pages printed by the plural image forming devices 10. The image forming devices 10 and the server device 30 are connected to each other via a communication line N2.

In the case where the PC 20 utilizes the print function of the image forming device 10, the PC 20 transmits image data to the image forming device 10. The image data include an RGB value for each of plural pixels, and information (hereinafter referred to as “object information”) that indicates the type of the object (such as an image, a text, and a graphic, for example) for each pixel. The term “object” as used herein represents an element that is disposed in an image and that constitutes the image. The type of the object is not limited to those mentioned above.

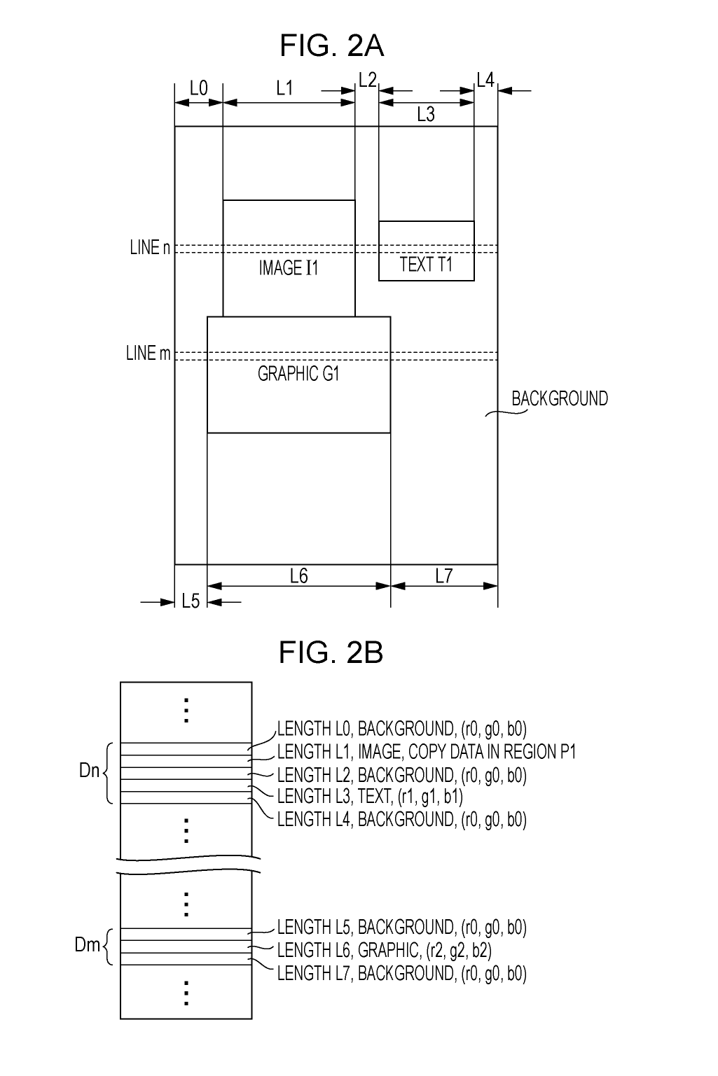

FIGS. 2A and 2B illustrate the data format of the image data transmitted to the image forming device 10. In the example, the image data have a data structure in which an object is disposed in a region (page) with a specified size. That is, the image data include information that specifies the size of a page, information that specifies the position of an object in the page, information that indicates the type of the object, and data that indicate the content of the object. The object is classified into an image, a text, and a graphic in accordance with the nature of the object. The image is an object such as a photograph and an illustration in which the color value is specified for each pixel. The text is an object that represents a character or a symbol specified by a character code. The graphic is an object that represents a geometric figure such as an ellipse and a polygon.

FIG. 2A illustrates an example of the arrangement of objects in a certain page. In the example, an image I1, a text T1, and a graphic G1 are included in one page. The region of the page other than the objects constitutes the background of the page. FIG. 2B illustrates image data for the page illustrated in FIG. 2A. In the example, the RGB value for each of the pixels constituting the image is included in a region (not illustrated) in the image data. Among the image data illustrated in FIG. 2B, a region Dn includes data corresponding to a line n of the page illustrated in FIG. 2A. In the region Dn, it is indicated that: pixels for a length L0 correspond to the background with an RGB value of (r0, g0, b0); pixels for a length L1 correspond to an image in which the RGB value for each of the pixels constituting the image is included in a region P1 in the image data (data in the region P1 may be copied); pixels for a length L2 correspond to the background with an RGB value of (r0, g0, b0); pixels for a length L3 correspond to a text with an RGB value of (r1, g1, b1); and pixels for a length L4 correspond to the background with an RGB value of (r0, g0, b0). A region Dm includes data corresponding to a line m of the page illustrated in FIG. 2A. In the region Dm, it is indicated that: pixels for a length L5 correspond to the background with an RGB value of (r0, g0, b0); pixels for a length L6 correspond to a graphic with an RGB value of (r2, g2, b2); and pixels for a length L7 correspond to the background with an RGB value of (r0, g0, b0). The data format of the image data is not limited to the format illustrated in FIGS. 2A and 2B, and may be any data format that specifies the RGB value for each of plural pixels and the type of the object for each of the pixels.

The image forming device 10 converts an RGB value included in the image data acquired from the PC 20 into a CMYK value, and forms an image on paper using the converted image data. In the case where the image forming device 10 converts an RGB value into a CMYK value, different image processing is occasionally performed in accordance with the type of the object constituted by the pixels to be converted. In this case, a certain RGB value may be converted into different CMYK values because of the difference between the types of the objects. As a result, different types of objects that have been displayed with the same RGB value on a display section of the PC 20 may be formed with different CMYK values on paper. In the case where such an issue occurs for plural objects that are adjacent to each other or plural objects that overlap each other, a difference in color (hereinafter referred to as a “color level difference”) is perceived at the boundary between the objects.

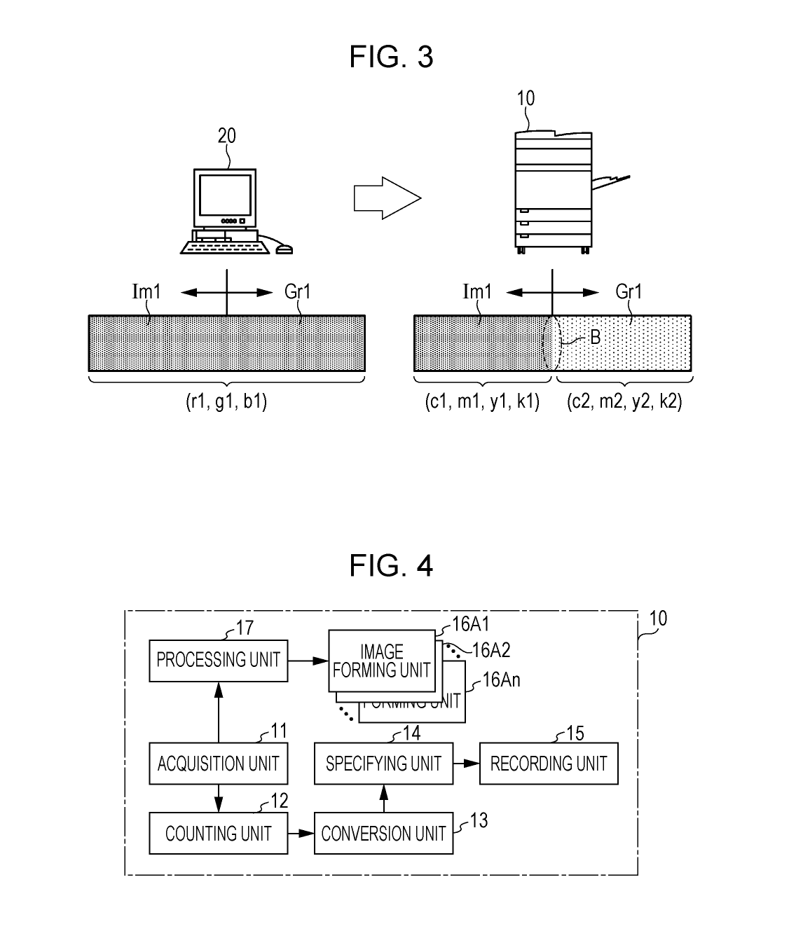

FIG. 3 illustrates an example of the color level difference. In the example, an image Im1 and a graphic Gr1 are displayed next to each other on the display section of the PC 20. Both the image Im1 and the graphic Gr1 have an RGB value of (r1, g1, b1). In the example, in addition, the image forming device 10 converts the RGB value of the image Im1 into a CMYK value of (c1, m1, y1, k1), and converts the RGB value of the graphic Gr1 into a CMYK value of (c2, m2, y2, k2). As a result, in the image formed by the image forming device 10, a boundary region B between the image Im1 and the graphic Gr1 has a color level difference. The information processing system 1 determines a possibility of occurrence of a color level difference (risk of occurrence of a color level difference) for each page, and counts the number of pages with such a possibility.

FIG. 4 is a block diagram illustrating the functional configuration of the image forming device 10. The image forming device 10 includes an acquisition unit 11, a counting unit 12, a conversion unit 13, a specifying unit 14, a recording unit 15, plural image forming units 16 (16A1, 16A2, . . . , and 16An), and a processing unit 17. The acquisition unit 11 acquires, for each page, image data including a color value for each of plural pixels and object information. The color value included in the image data acquired by the acquisition unit 11 is a color value in a first color space (e.g. an RGB color space) in which primary colors are mixed to express a color. The counting unit 12 counts the number of pixels included in the image data for each combination of the color value and the type of the object for each of the pages for which the image data have been acquired. The conversion unit 13 converts the color values for at least some of plural pixels from a color value in the first color space into a color value in a second color space (e.g. an HSV color space) including at least one of luminance and luminosity components. The specifying unit 14 specifies, for at least some of plural pixels, a color region to which such pixels belong in the second color space from color regions after the conversion. The term “color region” represents each of plural regions obtained by dividing the second color space in accordance with the color value. For example, in the case where the second color space is an HSV color space, the second color space is divided into plural regions in accordance with an HSV value (hue, saturation, and luminosity).

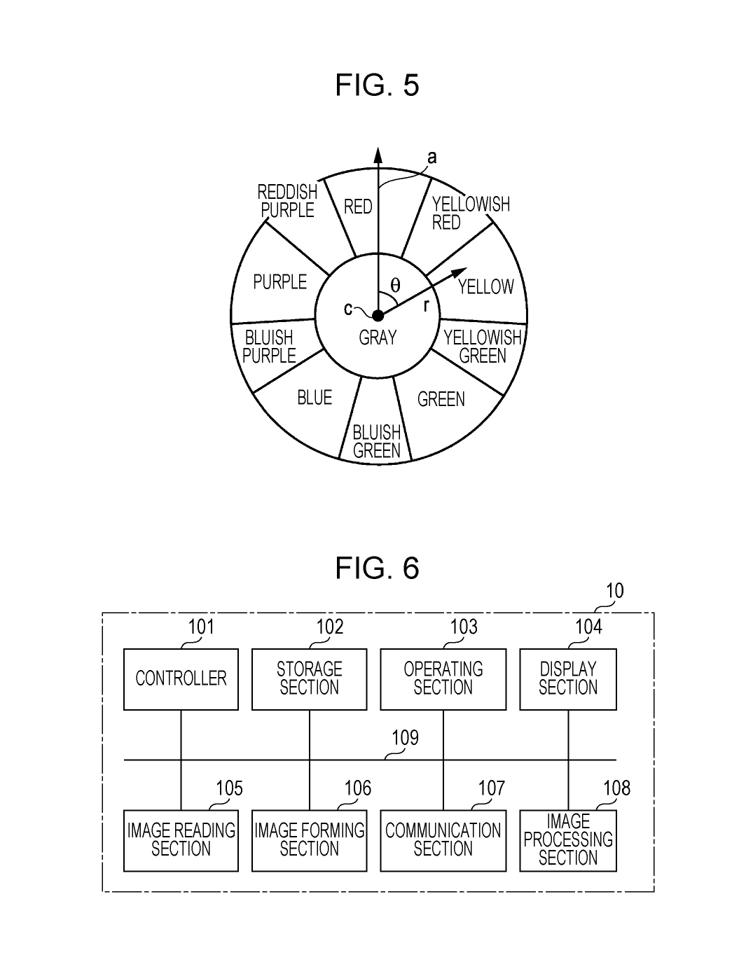

FIG. 5 illustrates color regions in the HSV color space. FIG. 5 illustrates a surface with a constant luminosity in the HSV color space. In the HSV color space illustrated in FIG. 5, the saturation and the hue are expressed by the distance r from the origin and the declination angle θ from a reference axis a, respectively, using a polar coordinate system with the center c of a circle defined as the origin. A gray color region is assigned to a region with a relatively low saturation (a region that is close to the center of the circle). Color regions are defined in accordance with the hue in a region with a relatively high saturation. In the example, the color regions change in the order of red, yellowish red, yellow, yellowish green, green, bluish green, blue, bluish purple, purple, and reddish purple in the clockwise direction.

FIG. 4 is referenced again. The recording unit 15 records the number of pages (hereinafter referred to as the “number of risk pages” in the sense that such pages involve a risk of occurrence of a color level difference) including plural pixels, the difference between the color values of which is less than a threshold determined in advance and the types of the objects of which are different from each other. Because the positions of the plural pixels are not considered, there is not necessarily a color level difference occurring in pages including plural pixels, the difference between the color values of which is less than the threshold determined in advance and the types of the objects of which are different from each other. However, such pages are treated as pages with a risk of occurrence of a color level difference. The recording unit 15 records the number of risk pages for each color region. The plural image forming units 16 form an image with different color components. The processing unit 17 performs a process for converting the image data acquired by the acquisition unit 11 into image data expressed in a color space composed of color components of the plural image forming units 16. The process performed by the processing unit 17 differs in accordance with the type of the object.

FIG. 6 is a block diagram illustrating the hardware configuration of the image forming device 10. As illustrated in the drawing, the image forming device 10 includes a controller 101, a storage section 102, an operating section 103, a display section 104, an image reading section 105, an image forming section 106, a communication section 107, and an image processing section 108. In addition, the various sections of the image forming device 10 are connected to a bus 109 and exchange various data via the bus 109.

The controller 101 is a unit that controls operation of the various sections of the image forming device 10. The controller 101 includes a computation processing device such as a central processing unit (CPU), and a storage medium (principal storage device) such as a read only memory (ROM) and a random access memory (RAM). The CPU reads a program stored in the ROM and the storage section 102, and executes the program using the RAM as the working area. By executing the program, the controller 101 forms (prints) an image on paper, reads an image from a document to generate image data, communicates with another device via a communication line, and so forth.

The storage section 102 is a unit that stores data. The storage section 102 includes a storage medium (auxiliary storage device) such as a hard disk drive and a flash memory, and stores data received by the communication section 107, data generated by the image forming device 10, and so forth. In addition, the storage section 102 may include a removable storage medium (removable medium) such as a so-called memory card and a USB memory, and a unit that reads and writes data from and into the storage medium. The storage section 102 stores a recording program and an image forming program to be discussed later.

The operating section 103 is a unit that receives an operation by a user. The operating section 103 includes an operator (such as a button and a key), and supplies the controller 101 with a control signal that matches the depressed operator. In addition, the operating section 103 may be constituted of a touch panel that includes the display section 104 and a sensor provided over a display screen of the display section 104 to supply the controller 101 with a control signal matching the pressed position.

The display section 104 is a unit that displays information. The display section 104 includes a liquid crystal display, for example, as the display device. Under control by the controller 101, the display section 104 displays a menu screen for operating the image forming device 10.

The image reading section 105 is a unit that reads a document and that converts the document into image data. The image reading section 105 includes an image reading device that optically reads a document and that generates image data that represent an image of the read document. The image reading section 105 supplies the generated image data to the image processing section 108.

The image forming section 106 is a unit that forms an image on paper. The image forming section 106 includes an image forming mechanism that forms toner images of cyan (C), magenta (M), yellow (Y), and black (K) color components on paper through electrophotography. The image forming mechanism may use other recording systems such as an inkjet system, rather than electrophotography.

The communication section 107 is a unit that transmits and receives data. The communication section 107 is connected to the communication lines N1 and N2 and functions as a communication interface to communicate with the PC 20, the server device 30, and the other image forming devices 10.

The image processing section 108 is a unit that executes image processing on image data. Examples of the image processing include color correction and tone correction. In the case where the image forming device 10 executes a print function, the image processing section 108 supplies the image forming section 106 with image data that have been subjected to the image processing.

In FIG. 6, the communication section 107 which is controlled by the controller 101 which executes a recording program for recording the number of pages with a possibility of occurrence of a color level difference is an example of the acquisition unit 11. The controller 101 which executes the recording program is an example of the counting unit 12, the conversion unit 13, the specifying unit 14, and the recording unit 15. In addition, the image forming section 106 controlled by the controller 101 which executes an image forming program for forming an image on paper is an example of the plural image forming units 16. The controller 101 which executes the image forming program is an example of the processing unit.

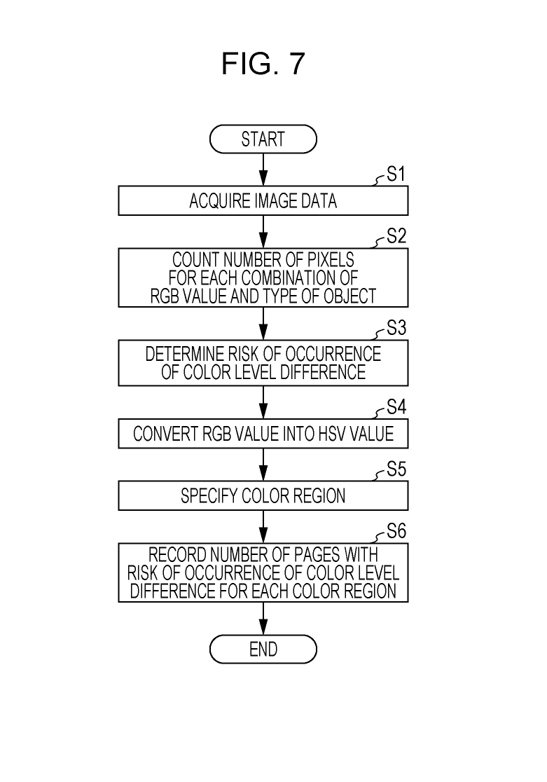

FIG. 7 is a flowchart illustrating a process in which the image forming device 10 records the number of pages with a risk of occurrence of a color level difference. The following process is started when an instruction for utilizing the print function (hereinafter referred to as a “print instruction”) is input to the image forming device 10. The print instruction is input, for example, by the user operating an operator (such as a keyboard or a mouse) of the PC 20. A process in which the image forming device 10 executes the print function is performed separately from the process illustrated in FIG. 7. In the print function, the controller 101 converts image data acquired in the process in step S1 to be discussed later into image data expressed in a CMYK color space, and forms toner images of C, M, Y, and K color components on paper.

In step S1, the controller 101 acquires image data for one or plural pages. Specifically, the controller 101 acquires image data from the PC 20. The image data include an RGB value (an example of the color value) for each of plural pixels and object information. The image data also include an RGB value for the background of each page. No object information is included for pixels constituting the background. The controller 101 stores the acquired image data in the RAM.

In step S2, the controller 101 counts the number of pixels included in the image data for each combination of the RGB value and the type of the object for each of the pages for which the image data have been acquired. The controller 101 counts the number of pixels by specifying the RGB value and the type of the object for each pixel by scanning the image data for one page in the order determined in advance (e.g. from the upper left pixel toward the lower right pixel of the page). The controller 101 stores, in the RAM, information (hereinafter referred to as “number-of-pixels information”) on the number of pixels for each combination of the RGB value and the type of the object (hereinafter referred to as a “combination-specific number of pixels”) for each of the pages.

In the case where the number of pixels with a certain RGB value located successively is not more than a threshold Th2 determined in advance, the controller 101 does not count the number of pixels for the combination of the RGB value of such pixels and the type of the object of such pixels. Consequently, in the case where the RGB value varies stepwise among successive pixels in a certain object (e.g. in the case where an image that represents a natural object is included in the image data), the number of pixels is not counted for each of such pixels. As a result, in the case where the RGB value varies stepwise among the successive pixels in the certain object, it is possible to prevent determination of a risk of occurrence of a color level difference in the process in step S3 to be discussed later because the number of pixels is counted for each of the successive pixels for a page that includes the certain object.

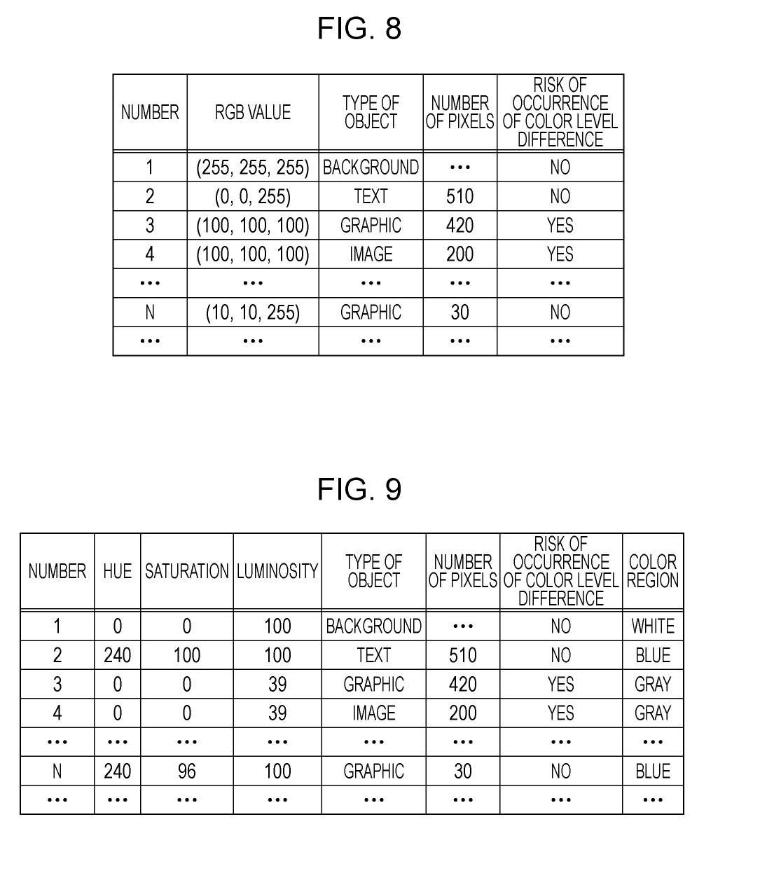

FIG. 8 illustrates the number-of-pixels information for a certain page. In FIG. 8, combinations of the RGB value and the type of the object are illustrated in the descending order of the combination-specific number of pixels. Three values in the RGB value indicate tones of red, green, and blue. In the example, the tones are represented in 256 steps from 0 to 255. In FIG. 8, the RGB value (255, 255, 255) with the type of the object “background” represents the RGB value of the background of the certain page. To be exact, the background of a page is not an object. However, pixels constituting the background have “background” in the field of the type of the object. FIG. 8 indicates that the certain page includes 510 pixels with an RGB value of (0, 0, 255) and having “text” as the type of the object, 420 pixels with an RGB value of (100, 100, 100) and having “graphic” as the type of the object, 200 pixels with an RGB value of (100, 100, 100) and having “image” as the type of the object, . . . , and 30 pixels with an RGB value of (10, 10, 255) and having “graphic” as the type of the object.

FIG. 7 is referenced again. In step S3, the controller 101 determines a risk of occurrence of a color level difference using the number-of-pixels information. Specifically, the controller 101 determines whether or not the number-of-pixels information includes combinations with the same RGB value and having different types of the object. The controller 101 stores information indicating that there is a risk of occurrence of a color level difference in correlation with each of combinations with the same RGB value and having different types of the object included in the number-of-pixels information. In step S3, in addition, the controller 101 also determines a risk of occurrence of a color level difference at the boundary between the background of the page and the object. Specifically, the controller 101 determines whether or not the number-of-pixels information includes pixels other than the background and with the same RGB value as the RGB value of the background. In the case where the number-of-pixels information includes pixels with the same RGB value as the RGB value of the background, the controller 101 stores information indicating that there is a risk of occurrence of a color level difference in correlation with such an RGB value in the number-of-pixels information. In step S3, the controller 101 determines a risk of occurrence of a color level difference for combinations, the combination-specific number of pixels for which meets a condition determined in advance. For example, the controller 101 determines a risk of occurrence of a color level difference for combinations, the combination-specific number of pixels for which is more than a number determined in advance. In another example, the controller 101 determines a risk of occurrence of a color level difference for combinations, the combination-specific number of pixels for which is one of the largest to the predetermined number-th largest in the number-of-pixels information. Consequently, a risk of occurrence of a color level difference is not determined for combinations, the combination-specific number of pixels for which is relatively small.

FIG. 8 is referenced again. In FIG. 8, it is determined that there is a risk of occurrence of a color level difference for pixels with an RGB value of (100, 100, 100) and having “graphic” as the type of the object and pixels with an RGB value of (100, 100, 100) and having “image” as the type of the object. In addition, it is determined that there is not a risk of occurrence of a color level difference for pixels constituting the background of the page, pixels with an RGB value of (0, 0, 255) and having “text” as the type of the object, and pixels with an RGB value of (10, 10, 255) and having “graphic” as the type of the object.

FIG. 7 is referenced again. In step S4, the controller 101 converts an RGB value included in the number-of-pixels information into an HSV value in the HSV color space. For example, the controller 101 converts an RGB value into an HSV value for combinations for which a risk of occurrence of a color level difference is determined in step S3. The conversion from an RGB value into an HSV value (hereinafter referred to an “HSV conversion”) is performed utilizing a formula determined in advance. The controller 101 stores the number-of-pixels information after the conversion in the RAM.

FIG. 9 illustrates the number-of-pixels information for the certain page after the HSV conversion. FIG. 9 illustrates a state in which an RGB value included in the number-of-pixels information illustrated in FIG. 8 has been subjected to an HSV conversion. In the example, the hue is represented in the range of 0° to 360°. The saturation and the luminosity are represented in the range of 0 to 100. In FIG. 9, an RGB value of (255, 255, 255) has been converted into an HSV value of (0, 0, 100), an RGB value of (0, 0, 255) has been converted into an HSV value of (240, 100, 100), an RGB value of (100, 100, 100) has been converted into an HSV value of (0, 0, 39), . . . , and an RGB value of (10, 10, 255) has been converted into an HSV value of (240, 96, 100).

FIG. 7 is referenced again. In step S5, the controller 101 specifies a color region corresponding to each of the HSV values included in the number-of-pixels information. The storage section 102 stores data that define the correlation between the HSV value (the values of hue, saturation, and luminosity components) and the color region. The controller 101 references the data to specify the color region. The controller 101 stores the specified color region in correlation with the HSV value in the number-of-pixels information.

FIG. 9 is referenced again. In FIG. 9, the color region for the HSV value (0, 0, 100) is specified as “white”, the color regions for the HSV value (240, 100, 100) and the HSV value (240, 96, 100) are specified as “blue”, and the color region for the HSV value (0, 0, 39) is specified as “gray”.

FIG. 7 is referenced again. In step S6, the controller 101 records the number of pages with a risk of occurrence of a color level difference for each color region. Specifically, the controller 101 references the number-of-pixels information for each of the pages, and counts the number of pages with a risk of occurrence of a color level difference for each color region. The controller 101 records the counted number of pages in the storage section 102. For example, for the page, the number-of-pixels information for which is indicated in FIG. 9, one page is counted for the color region “gray”. In the case where there is a risk of occurrence of a color level difference for plural different color regions in the number-of-pixels information, the number of pages is counted for each of the plural color regions.

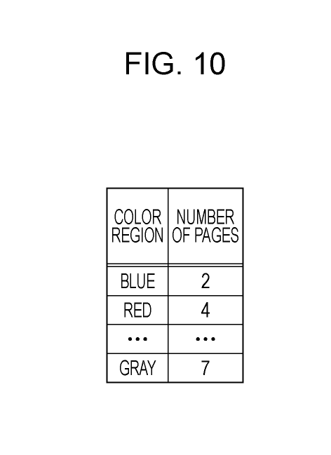

FIG. 10 illustrates an example in which the number of pages with a risk of occurrence of a color level difference is recorded for each color region. In the example of FIG. 10, the number of pages with a risk of occurrence of a color level difference is two pages, four pages, . . . , and seven pages for each of the color regions “blue”, “red”, . . . , and “gray”, respectively.

Through the process described above, the image forming device 10 records the number of pages with a risk of occurrence of a color level difference for each color region for the image data printed by the image forming device 10 itself. The number of pages recorded by each of the image forming devices 10 is transmitted to the server device 30. The server device 30 summarizes the number of pages with a risk of occurrence of a color level difference acquired from each of the image forming devices 10.

The present invention is not limited to the exemplary embodiment described above, and a variety of modifications may be made. Some modifications will be described below. The modifications described below may be used in combination of two or more.

The condition for the image forming device 10 to determine that there is a risk of occurrence of a color level difference at the boundary between objects is not limited to the condition described in relation to the exemplary embodiment. The image forming device 10 may determine that there is a risk of occurrence of a color level difference in the case where the number-of-pixels information includes combinations, the difference between the RGB values of which is less than a threshold Th1 determined in advance and the types of the objects of which are different from each other. The difference between the RGB values is calculated, for example, by totaling the difference for each component of the RGB values. In addition, the condition for the image forming device 10 to determine that there is a risk of occurrence of a color level difference at the boundary between the background of the page and an object is also not limited to the condition described in relation to the exemplary embodiment. The image forming device 10 may determine that there is a risk of occurrence of a color level difference in the case where the number-of-pixels information includes pixels other than the background, the difference of the RGB value of which from the RGB value of the background is less than a threshold Th3 determined in advance. The threshold Th3 may be the same as the threshold Th1.

The first color space is not limited to the RGB color space. The first color space may be a color space other than the RGB color space if a color level difference may occur in the case of conversion into a CMYK color space. In addition, the second color space is not limited to the HSV color space. The second color space may be an HLS color space (a color space defined by hue, saturation, and luminance) or a Lab color space (a color space defined by luminosity and two complementary color components).

The process executable in the present invention is not limited to the process illustrated in FIG. 7. For example, in step S2, the controller 101 may count the number of pixels for a part of the image data. In a specific example, the controller 101 may count the number of pixels after dropping plural pixels included in the image data at intervals determined in advance. In another specific example, the controller 101 may count the number of pixels for only pixels located around the end portions of an object included in the image data. In this case, the controller 101 specifies the position of the end portions of the object using information that specifies the position of the object indicated by the image data.

In step S2, the controller 101 may count the number of pixels by specifying the RGB value for each pixel by scanning each of objects included in the image data for one page in the order determined in advance (e.g. from the upper left pixel toward the lower right pixel). For example, in the arrangement example of FIG. 2A, first, the RGB value is specified for the image I1 for each pixel in the order determined in advance to count the number of pixels. Next, the RGB value is specified for the text T1 for each pixel in the order determined in advance to count the number of pixels. Next, the RGB value is specified for the graphic G1 for each pixel in the order determined in advance to count the number of pixels. At last, the RGB value is specified for the background to count the number of pixels. Then, such numbers of pixels are summed to acquire number-of-pixels information.

In step S4, the controller 101 may convert an RGB value into an HSV value for combinations for which it is determined in step S3 that there is a risk of occurrence of a color level difference. In addition, in step S5, the controller 101 may specify the color region corresponding to the HSV value for combinations for which it is determined that there is a risk of occurrence of a color level difference.

The data format of the image data to be transmitted to the image forming device 10 is not limited to the format illustrated in FIGS. 2A and 2B. For example, image data in the bitmap format may be transmitted to the image forming device 10. In this case, the image forming device 10 performs an image analysis on the image data in the bitmap format and specifies the position of an object in a page, the type of the object, and the content of the object. Thus, the data format of the image data may be any data format as long as the color value for each of plural pixels and the type of the object for each pixel are specified.

The image forming device 10 may determine a risk of occurrence of a color level difference in consideration of the position of plural pixels. For example, the image forming device 10 may determine that there is a risk of occurrence of a color level difference in the case where plural pixels next to each other have the same RGB value and have different types of the object.

The image forming device 10 may specify the color region corresponding to each of the RGB values in the RGB color space without conversion from the RGB color space into the HSV color space. In this case, the process in step S4 is not performed.

The image forming device 10 may not record the number of pages with a risk of occurrence of a color level difference distinctively for each color region. In this case, the processes in steps S4 and S5 discussed above are not performed.

The color region is not limited to those defined by the values of hue, saturation, and luminosity components. The color region may be defined by some of the values of hue, saturation, and luminosity components. In addition, the color region is not limited to those described in relation to the exemplary embodiment.

The information processing apparatus is not limited to the image forming device 10. For example, the PC 20 or the server device 30 may perform the processes illustrated in FIG. 7.

The hardware configuration of the image forming device 10 is not limited to the configuration illustrated in FIG. 6. Each device may have any hardware configuration as long as the processes illustrated in FIG. 7 are executed.

The recording program and the image forming program executable by the image forming device 10 in the exemplary embodiment may be provided as stored in a computer readable storage medium such as a magnetic storage medium (such as a magnetic tape and a magnetic disk (such as an HDD and a flexible disk (FD))), an optical storage medium (such as an optical disk (such as a compact disk (CD) and a digital versatile disk (DVD))), a magneto-optical storage medium, and a semiconductor memory (such as a flash ROM). Alternatively, such programs may be downloaded by way of a network such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires, for each page, image data including a color value for each of a plurality of pixels and information that indicates a type of an object for each of the pixels; and
a recording unit that records a number of pages including a plurality of pixels, a difference between the color values of which is less than a first threshold determined in advance and the types of the objects of which are different from each other.

2. The information processing apparatus according to claim 1, further comprising:
a counting unit that counts a number of pixels included in the image data for each combination of the color value and the type of the object for each of the pages,
wherein the recording unit records the number of pages for combinations, the number of pixels counted for which by the counting unit meets a condition determined in advance.

3. The information processing apparatus according to claim 2,
wherein in a case where the number of pixels with a certain color value located successively in the image data is not more than a second threshold determined in advance, the counting unit does not count the number of pixels for the combination of the color value of such pixels and the type of the object of such pixels.

4. The information processing apparatus according to claim 1,
wherein the image data include a color value of a background of the page, and
the recording unit records the number of pages including pixels other than the background, a difference of the color value of which from the color value of the background is less than a third threshold determined in advance.

5. The information processing apparatus according to claim 1, further comprising:
a specifying unit that specifies, for at least some of the plurality of pixels, a color region to which such pixels belong in a color space determined in advance,
wherein the recording unit records the number of pages for each color region to which a plurality of pixels belong, the difference between the color values of the plurality of pixels being less than the first threshold determined in advance and the types of the objects of the plurality of pixels being different from each other.

6. The information processing apparatus according to claim 5, further comprising:
a conversion unit that converts the color value of at least some of the plurality of pixels from a color value in a first color space, in which primary colors are mixed to express a color, into a color value in a second color space including at least one of luminance and luminosity components,
wherein the specifying unit specifies, for at least some of the plurality of pixels, a color region to which such pixels belong in the second color space from the color value after the conversion.

7. The information processing apparatus according to claim 1, further comprising:
a plurality of image forming units that form an image with different color components; and
a processing unit that performs a process for converting the image data acquired by the acquisition unit into image data expressed in a color space composed of color components of the plurality of image forming units,
wherein the process differs in accordance with the type of the object.

8. A non-transitory computer readable medium storing a program causing a computer to execute a process comprising:
Acquiring, for each page, image data including a color value for each of a plurality of pixels and information that indicates a type of an object for each of the pixels; and
recording a number of pages including a plurality of pixels, a difference between the color values of which is less than a first threshold determined in advance and the types of the objects of which are different from each other.
